(19) United States
(12) Patent Application Publication
(10) Pub. No.: US 2011/0320683 A1
(43) Pub. Date: Dec. 29, 2011

(54) Information processing system, resynchronization method and storage medium storing firmware program

(75) Inventors: Toshikazu Ueki, Kawasaki (JP); Makoto Hataida, Kawasaki (JP); Takaharu Ishizuka, Kawasaki (JP); Yuka Hosokawa, Kawasaki (JP); Takashi Yamamoto, Kawasaki (JP); Kenta Sato, Kawasaki (JP)

(73) Assignee: FUJITSU LIMITED, Kawasaki (JP)

(21) Appl. No.: 13/137,671

(22) Filed: Sep. 1, 2011

Related U.S. Application Data
(63) Continuation of application No. PCT/JP2009/054305, filed on Mar. 6, 2009.

(51) Int. Cl. G06F 12/00

(52) U.S. Cl. 711/102; 711/E12.001

(57) ABSTRACT

An information processing system includes sets of multiple processors performing processing synchronously. The system includes: a ROM storing a firmware program activating the processors to a synchronized state; a RAM defined by one address map; a firmware copying section copying the firmware program in the ROM to the RAM, on system boot; and a RAM address register storing an address of the RAM and of a copy destination of the firmware program. The system further includes: a RAM address storing section storing the address of the RAM and of the copy destination of the firmware program; a loss-of-synchronism detection section detecting loss of synchronism of the processors; and an address replacing section referring to the RAM address register upon detection of the loss of synchronism, thereby replacing an address for reading the stored firmware program, with the address of the RAM and of the copy destination of the firmware program.

### CROSS-REFERENCE TO RELATED APPLICATION

This is a continuation application of PCT/JP2009/054305, filed on Mar. 6, 2009.

### FIELD

Embodiments discussed herein are directed to an information processing system, a resynchronization method, and a storage medium storing a firmware program.

### BACKGROUND

In an information processing system such as a mission critical server system or the like desired to perform continuous operation, a system failure causes a large effect and thus, there is a demand for high reliability to the extent that the system hardly stops. There is a method of causing two CPUs (processors) to perform synchronous dual operation, in order to improve reliability. In the case of this synchronous dual CPU system, system operation may continue even when a failure occurs in one of the pair of CPUs during synchronous dual operation. Further, it is desirable to improve reliability by restoring the synchronous operation (resynchronization) of the CPU, thereby increasing the time during which the synchronous dual operation is performed. At the time of the resynchronization, downtime is long if the system is rebooted and therefore, it is desirable to carry out the resynchronization without performing a system reboot.

FIG. 1 is a block diagram that illustrates an example of a configuration of an information processing system.

An information processing system 10 illustrated in this FIG. 1 includes three system boards 20_1, 20_2 and 20_3. The system boards 20_1, 20_2 and 20_3 include two CPUs 21_A and 21_B, two CPUs 21_C and 21_D, and two CPUs 21_E and 21_F, respectively. Further, the system boards 20_1, 20_2 and 20_3 include: main storage RAMs (volatile memories) 22_1, 22_2 and 22_3; firmware ROMs (non-volatile memories) 23_1, 23_2 and 23_3; and system control circuits 24_1,24_2 and 24_3, respectively.

The two CPUs; 21_A and 21_B, 21_C and 21_D, and 21_E and 21_F of the respective system boards 20_1, 20_2 and 20_3 are synchronous dual CPUs that perform the same processing in synchronization with each other.

The main storage RAMs 22_1, 22_2 and 22_3 are random-access memories used as working areas in the processing at the CPUs; 21_A and 21_B, 21_C and 21_D, and 21_E and 21_F. These main storage RAMs 22_1, 22_2 and 22_3 are defined by a single address map for all the main storage RAMs 22_1, 22_2 and 22_3, to avoid the respective addresses from overlapping one another. This allows any of the system boards 20_1, 20_2 and 20_3 to refer to the contents of the main storage RAM in other system board. Therefore, data may be exchanged between the system boards 20_1, 20_2 and 20_3.

Furthermore, a firmware program for activating the synchronous dual CPUs to bring the CPUs to a synchronous state is stored in the firmware ROMs 23_1, 23_2 and 23_3.

Incidentally, FIG. 1 illustrates the three system boards 20_1, 20_2 and 20_3, but the number of the system boards is not limited to three.

Further, the information processing system 10 illustrated in FIG. 1 includes three IO control circuits 30_1, 30_2, 30_3, and an interconnect 40. Here, what kind of IO each of these three IO control circuits 30_1, 30_2, 30_3 controls does not matter. Moreover, the number of the IO control circuits of one information processing system 10 is not limited to three, and may not agree with the number of the system boards. Furthermore, the interconnect 40 transfers signals between the system boards 20_1, 20_2, 20_3 and the IO control circuits 30_1, 30_2, 30_3.

This information processing unit IO further includes a system management device 50. This system management device 50 manages this entire information processing system 10.

There will be described below a method of performing resynchronization without carrying out a system reboot, in the information processing system configured as in FIG. 1. Here, the description will be provided assuming that loss of synchronism has occurred in the CPU 21_A that is one of the two CPUs 21_A and 21_B mounted on the system board 20_1.

When a redundancy (loss of synchronism) caused by a failure in the CPU 21_A is detected in the system control circuit 24_1, this abnormal CPU 21_A is separated. The normal CPU 21_B of the synchronous pair is notified of a halt on the CPU 21_A by an interrupt notice. Upon receipt of this interrupt notice, the CPUs 21_A and 21_B are reset for resynchronization. Here, the CPUs 21_A and 21_B in the course of resetting are not allowed to respond to a request such as an interrupt from other CPUs 21_C, 21_D, 21_E and 21_F, and the IO control circuits 31_1, 30_2 and 30_3. For this reason, an interrupt or the like from any of other CPUs 21_C, 21_D, 21_E and 21_F, and the IO control circuits 30_1, 30_2 and 30_3 to the CPUs 21_A and 21_B that are about to be resynchronized is stopped. At this moment, an OS (Operating System) is temporarily suspended.

The normal CPU 21_B saves minimum CPU internal information to be used at the time of resynchronization into the main storage RAM 22_1, and also saves a cache of the CPU into the main storage RAM 22_1.

At the time when this processing is completed, the CPUs 21_A and 21_B are reset at the same time, and the CPU synchronous operation is resumed. The CPUs 21_A and 21_B after reset read firmware from the firmware ROM 23_1, and after starting the firmware, restore the information saved into the main storage RAM 22_1 to the CPUs 21_A and 21_B. Lastly, the halt on the interrupt or the like for the CPUs 21_A and 21_B to be resynchronized is released, and the OS is caused to return.

FIG. 2 is a diagram that illustrates a time sequence in the resynchronization method described above.

Here, the CPU 21_A, CPU 21_B, and other CPUs 21_C, 21_D, 21_E, and 21_F are referred to as “CPU A”, “CPU B”, and “other CPUs”, respectively.

When loss of synchronism occurs in the CPU A, firmware processing, namely, prohibition of interrupts, saving of the CPU cache into the main storage RAM, and the like, is performed in the CPU B, and other CPUs are stopped.

In the CPU A and the CPU B, reset and reading out of firmware are performed and further, the firmware processing such as restoration of the information saved into the main storage RAM and release of the prohibition of interrupts is performed. Subsequently, the CPU A, the CPU B, the other CPUs are all returned to normal operation.

Here, in particular, reading the firmware out of the firmware ROM consumes the time and thus, it takes a long time to complete the resynchronization. In particular, when a flash ROM is employed as the firmware ROM, since the flash ROM typically operates at a slow-speed frequency (around a few tens of MHz) and has a small bus width, it takes a long time to read the firmware from the flash ROM to start the firmware.

During the resynchronization, the OS halts and thus, work of a system user is suspended. Further, since a packet in the system is stopped, there arises such a problem that a large value is desired to set timeout of each module. In other words, in a case where a general-purpose module is used, there is a possibility that this timeout may become a value larger than expected and the resynchronization method described above may not be adopted.

As a way of reducing warm-up time in the resynchronization, there is such a suggestion that the firmware program is moved from the ROM to the RAM on starting, and the firmware program is read from the RAM on restarting. In this suggestion, switching between the RAM and the ROM is performed by an end selector.

However, in the case of an ordinary synchronous dual CPU configuration, the firmware ROM is provided for each CPU or each CPU group, whereas the main storage RAM is defined by the single address map to avoid overlap among addresses in the system as a whole, as described above. In such a configuration, if an attempt is made to adopt the conventionally proposed way in which the firmware program is moved to the RAM, it is desirable to prepare a dedicated RAM for each ROM separately, increasing the cost. Further, there is a case where the firmware ROM is used not only for reading out, but also for writing to save error information or retain configuration information. The error information and the like may not be saved into a volatile RAM. Therefore, when switching between the ROM and the RAM is performed in an end part as in the conventional proposal, exclusive control between CPUs is desired, making the control complicated.

Furthermore, conventionally, there have been proposed: to cancel redundancy when one of synchronous dual CPUs fails, and perform operation only with the other CPU; and to carry out a transfer of processing within a short time by copying modified data in a system currently in use to a standby system. However, keeping the operation with the other CPU alone may not avoid a deterioration in reliability, and the proposal of copying the modified data in the system currently in use to the standby system is not directly related to the loss of synchronism.

For example, refer to Japanese Laid-open Patent Publications No. 63-268030, No. 8-235125, No. 7-200334, and No. 2008-140080 for reference.

A challenge in an information processing system, a resynchronization method and a firmware program of Japanese Laid-open Patent Publication No. 2008-140080 is to shorten the timeout at the time of occurrence of loss of synchronism and perform restoration to a state with high reliability, in the information processing system mounted with two or more pairs of dual CPUs operating synchronously.

### SUMMARY

According to an aspect of the invention, an information processing system includes a plurality of sets of two or more multiple CPUs that perform processing in synchronization with each other. The information processing system further includes a ROM, a RAM, a firmware copying section, a RAM address register, a RAM address storing section, a loss-of-synchronism detection section, and an address replacing section. The ROM stores a firmware program activating the multiple CPUs to a state in which the multiple CPUs are synchronized with each other. The RAM is defined by one address map as a whole. The firmware copying section copies the firmware program stored in the ROM to the RAM, on system boot. In the RAM address register, an address of the RAM and of a copy destination to which the firmware program is copied is stored. The RAM address storing section stores the address of the RAM and of the copy destination to which the firmware program is copied by the firmware copying section, in the RAM address register. The loss-of-synchronism detection section detects loss of synchronism of the multiple CPUs. The address replacing section refers to the RAM address register in response to the loss of synchronism being detected by the loss-of-synchronism detection section, thereby replacing an address for reading the firmware program stored in the ROM, with the address of the RAM and of the copy destination of the firmware program.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram that illustrates an example of a configuration of an information processing system;

FIG. 2 is a diagram that illustrates a time sequence in the resynchronization method described above;

FIG. 3 is a block diagram that illustrates a configuration of an information processing system in the first embodiment of the present case;

FIGS. 4(A) and 4(B) are a block diagram that illustrates a configuration of an information processing system according to a second embodiment of the present case;

FIGS. 5(A) and 5(B) are a diagram that illustrates an operating sequence of the firmware and the circuit in the second embodiment illustrated in FIG. 4;

FIG. 6 is a block diagram that illustrates a configuration of an information processing system according to the third embodiment of the present case;

FIG. 7 is a block diagram that illustrates a configuration of an information processing system according to the fourth embodiment of the present case;

FIG. 8 is a diagram sequentially illustrating operations when loss of synchronism occurs in the information processing system of the fourth embodiment illustrated in FIG. 7;

FIG. 9 is a diagram sequentially illustrating operations when loss of synchronism occurs in the information processing system of the fourth embodiment illustrated in FIG. 7;

FIG. 10 is a diagram sequentially illustrating operations when loss of synchronism occurs in the information processing system of the fourth embodiment illustrated in FIG. 7;

FIG. 11 is a diagram sequentially illustrating operations when loss of synchronism occurs in the information processing system of the fourth embodiment illustrated in FIG. 7;

FIG. 12 is a diagram sequentially illustrating operations when loss of synchronism occurs in the information processing system of the fourth embodiment illustrated in FIG. 7; and

FIG. 13 is a diagram sequentially illustrating an operation sequence of each section in the information processing system of the fourth embodiment illustrated in FIGS. 8-12.

### DESCRIPTION OF EMBODIMENTS

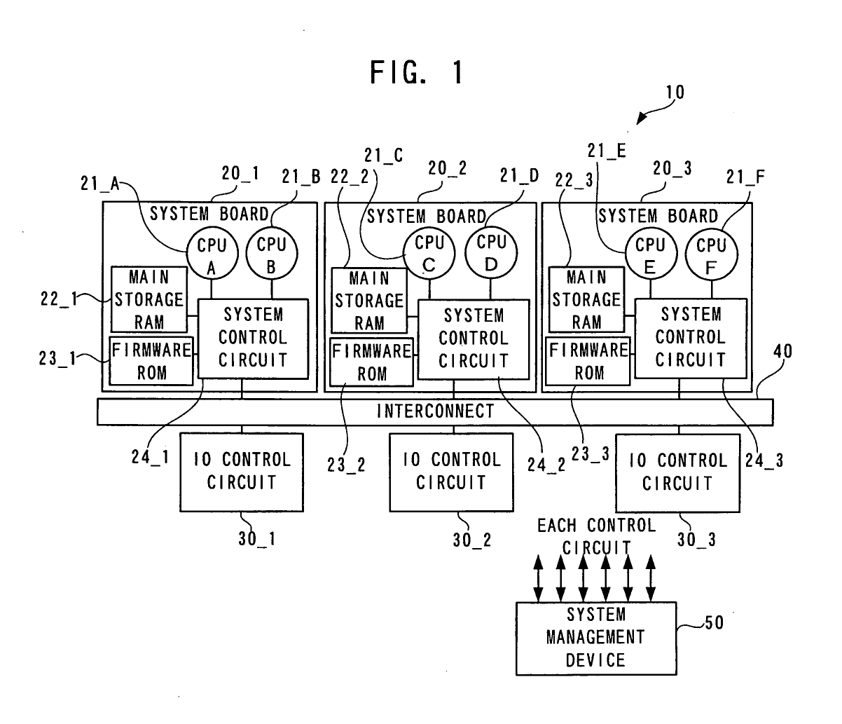

Embodiments of the present case will be described below. Incidentally, for a first embodiment to be described below, FIG. 1 will be used as an overall block diagram. However, the internal configurations of the system control circuits 24_1, 24_2 and 24_3 are slightly different.

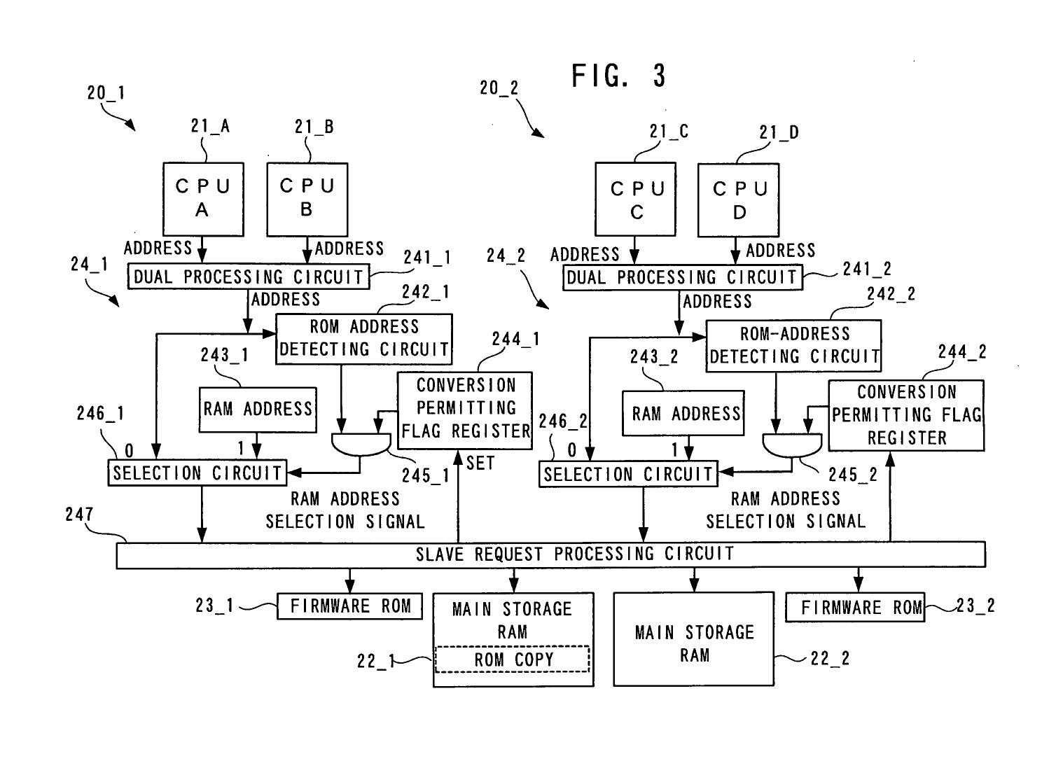

FIG. 3 is a block diagram that illustrates a configuration of an information processing system in the first embodiment of the present case. However, in order to avoid complication of illustration, this FIG. 3 illustrates two of the three system boards illustrated in FIG. 1. Further, as to the two system control circuits of these two system boards, only elements used for the resynchronization are illustrated. Furthermore, here, illustration of the interconnect 40 depicted in FIG. 1 is omitted, and slave request processing circuits included in the respective two system control circuits 24_1 and 24_2 are indicated collectively by one block.

In this FIG. 3, dual processing circuits 241_1 and 241_2 are illustrated as elements of the system control circuits 24_1 and 24_2 of the system boards 20_1 and 20_2 each illustrated as one block in FIG. 1, respectively. Further, ROM-address detecting circuits 242_1 and 242_2 and RAM address registers 243_1 and 243_2 are also illustrated as elements of the system control circuits 24_1 and 24_2, respectively. Furthermore, as the elements, conversion permitting flag registers 244_1 and 244_2, gate circuits 345_1 and 345_2 and selection circuits 246_1 and 246_2 are also illustrated. In addition, a slave request processing circuit 247 illustrated as one integral block for the two system control circuits 24_1 and 24_2 is also illustrated.

The dual processing circuits 241_1 and 241_2 perform operation for dual synchronous processing of the CPUs 21_A and 21_B, and 21_C and 21_D, respectively. In other words, these dual processing circuits 241_1 and 241_2 serve as a switch to select an address from one CPU of addresses output from two CPU bus interfaces and the two CPUs. Moreover, these dual processing circuits 241_1 and 241_2 perform processing such as detection of loss of synchronism in the two CPUs, respectively.

Further, the ROM-address detecting circuits 242_1 and 242_2 are circuits that detect whether the addresses output from the dual processing circuits 241_1 and 241_2 agree with firmware program storage addresses of the firmware ROMs 23_1 and 23_2.

Furthermore, the RAM address registers 243_1 and 243_2 are registers in which when the firmware programs in the firmware ROMs 23_1 and 23_2 are copied to the main storage RAMs 22_1 and 22_2, the addresses of the copy destinations are stored. The details will be described later.

Further, in each of the conversion permitting flag registers 244_1 and 244_2, a conversion permitting flag to allow conversion of the address of the firmware ROM into the address of the main storage RAM is stored. Each of these conversion permitting flag registers 244_1 and 244_2 is equivalent to an example of the copy flag register of the present case.

When satisfying the following two conditions (a) and (b) at the same time, the gate circuits 245_1 and 245_2 output RAM address selection signals for the conversion into the addresses of the main storage RAMs 22_1 and 22_2.

(a) The conversion permitting flags are stored in the conversion permitting flag registers 244_1 and 244_2.

(b) The storage addresses of the firmware programs in the firmware ROMs 23_1 and 23_2 are detected by the ROM-address detecting circuits 242_1 and 242_2.

Normally, the selection circuits 246_1 and 246_2 directly output the addresses received from the dual processing circuits 241_1 and 241_2. However, upon receipt of the RAM address selection signals from the gate circuits 245_1 and 245_2, the selection circuits 246_1 and 246_2 output the addresses of the main storage RAMs 22_1 and 22_2 stored in the RAM address registers 243_1 and 243_2.

Here, at the time of starting to the first initial state in which this information processing system is powered on, the conversion permitting flag is reset without being stored in each of the conversion permitting flag registers 244_1 and 244_2. For this reason, even when the firmware program storage addresses of the firmware ROMs 23_1 and 23_2 are detected by the ROM-address detecting circuits 242_1 and 242_2, the RAM address selection signal is not output from each of the gate circuits 245_1 and 245_2. The identical firmware programs are stored in the firmware ROMs 23_1 and 23_2. Therefore, upon power-on, the firmware program is read from either one of the firmware ROMs. Here, the firmware program is assumed to be read from the firmware ROM 23_1. When the address of the firmware ROM 23_1 is output from the dual processing circuit 241_1, the address of the firmware ROM 23_1 is directly output from the selection circuit 246_1, and input into the firmware ROM 23_1 via the slave request processing circuit 247. As a result, the firmware program is read from the firmware ROM 23_1. This firmware program performs initialization including the synchronization, in the two CPUs 21_A and 21_B and the two CPUs 21_C and 21_D. In this initialization, the firmware program read from the firmware ROM 23_1 is copied to the main storage RAM 22_1 by the operation of the firmware program. In addition, the RAM address of the copy destination of the main storage RAM 22_1 is stored in each of the RAM address registers 243_1 and 2432. Further, the conversion permitting flag is set to each of the conversion permitting flag registers 244_1 and 244_2.

It is to be noted that as described above, the same firmware programs are stored in the firmware ROMs 23_1 and 23_2 and thus, reading the firmware program from either one of the firmware ROMs is sufficient. Further, even when loss of synchronism occurs in any of the system boards, the firmware program may be read from the RAM that is the copy destination, in the resynchronization, and making any one of the RAMs to serve as the copy destination is sufficient.

However, the RAM address of the copy destination is stored in all the RAM address registers 243_1 and 243_2, and the conversion permitting flag also is set in all the conversion permitting flag registers 244_1 and 244_2.

After such initialization is performed, various kinds of processing are performed by the dual operation in each of the dual CPUs.

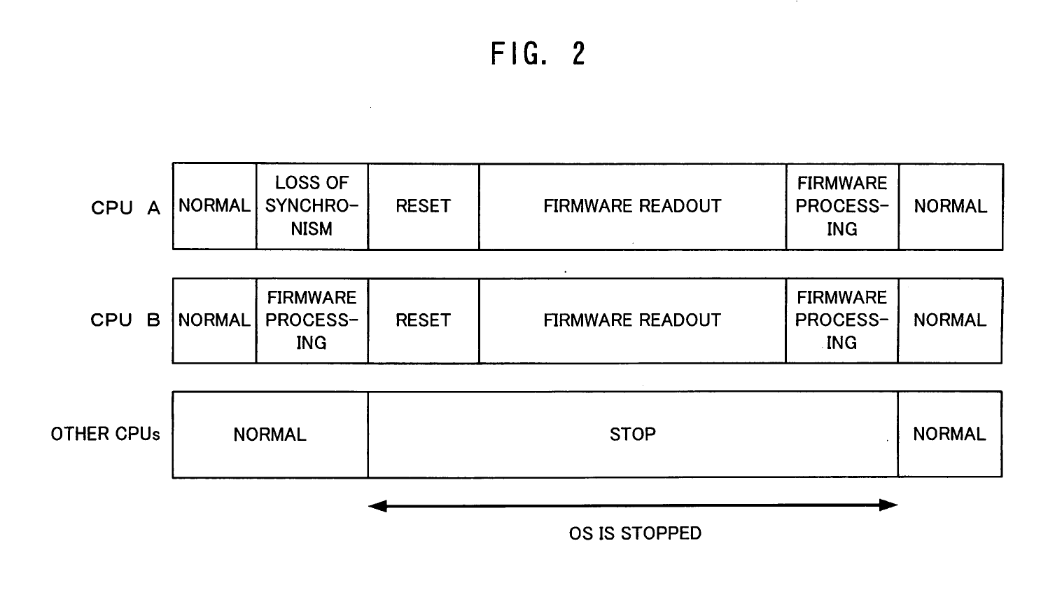

Suppose loss of synchronism has occurred in the CPU 21_A during execution of the processing. Then, the loss of synchronism is detected by the dual processing circuit 241_1. In this case, as described above with reference to FIG. 2, the resynchronization processing is executed by the main operation of the other CPU 21_B. In this resynchronization processing, the address of a firmware program storage area of the firmware ROM 23_1 is output from the CPU 21_B to read the firmware program from the firmware ROM 23_1, and the address output from the CPU 21_B is output in the dual processing circuit 241_1. At this moment, the firmware program storage address of the firmware ROM 23_1 which is output from the dual processing circuit 241_1 is detected in the ROM-address detecting circuit 242_1. Further, the conversion permitting flag is set in the conversion permitting flag register 244_1. For this reason, a RAM address selection signal is output from the gate circuit 245_1. Upon receipt of the RAM address selection signal, the selection circuit 246_1 outputs the address of the main storage RAM 22_1 stored in the RAM address register 243_1, in place of the address of the firmware ROM 23_1 output from the dual processing circuit 241_1. In other words, the CPU 21_B outputs the address of the firmware ROM 23_1, which is replaced with the address of the main storage RAM 22_1 in the selection circuit 246_1, and this address of the main storage RAM 22_1 is output. For this reason, the firmware program copied to the main storage RAM 22_1 is read out. In this way, in the CPUs 21_A and 21_B, the resynchronization processing is performed by the firmware program read from the main storage RAM 22_1.

Normally, the access speed of the main storage RAM 22_1 is much higher than that of the firmware ROM 23_1 and therefore, the time for the “firmware readout” illustrated in FIG. 2 is greatly reduced. For this reason, high-speed resynchronization may be carried out, allowing short-time returning to the state with high reliability.

Further, in the case of the configuration illustrated in this FIG. 3, a large increase in cost such as providing ROMs and RAMs separately in a one-to-one relationship may be avoided and thus, high-speed resynchronization is obtained by merely making a slight modification to a conventional circuit configuration.

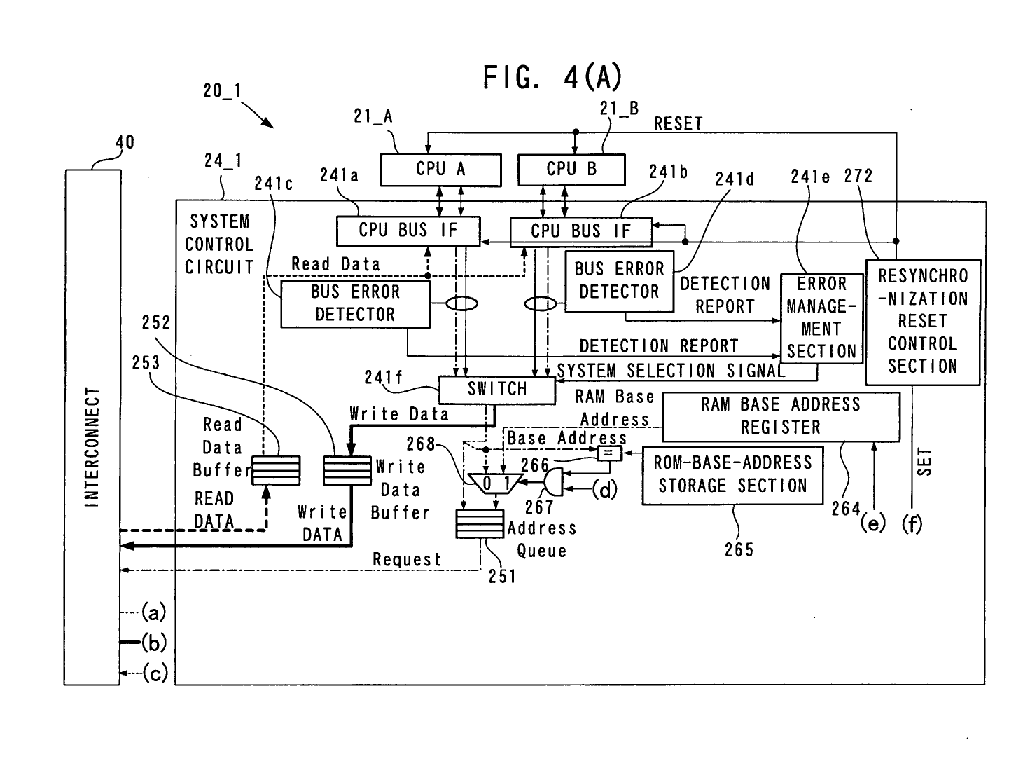

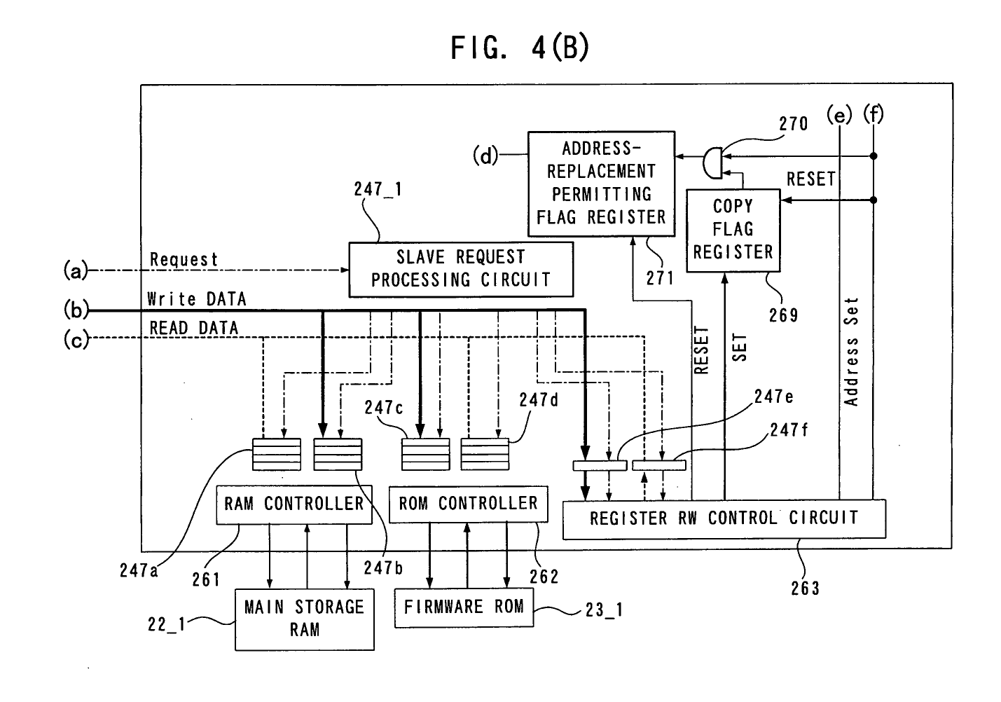

FIGS. 4(A) and 4(B) coupled with each other by connecting the same references ((a), (b), . . . , (f)) respectively are a block diagram that illustrates a configuration of an information processing system according to a second embodiment of the present case. This second embodiment also is the same as FIG. 1 in terms of overall configuration, but FIG. 4 illustrates only a configuration of one system board 20_1 to avoid complication of illustration. A system control circuit 24_1 of the system board 20_1 illustrated in FIG. 4 includes two CPU bus interfaces 241a and 241b corresponding to two CPUs 21_A and 21_B, respectively. Further, here, two bus error detectors 241c and 241d, and an error management section 241e, and a switch 241f are provided. As for the CPU bus interfaces 241a and 241b, the bus error detectors 241c and 241d, the error management section 241e, and the switch 241f combined correspond to each of the dual processing circuits 241_1 and 241_2 illustrated in FIG. 3. The bus error detectors 241c and 241d detect an error in address or data, namely, loss of synchronism, which is output from each of the CPUs 21_A and 21_B via the CPU bus interfaces 241a and 241b. A detection result obtained by each of the bus error detectors 241c and 241d is reported to the error management section 241e. When the two CPUs 21_A and 21_B operate synchronously, the error management section 241e changes the switch 241f so that the address and data from either one of these two CPUs 21_A and 21_B (for example, the CPU 21_A) is output.

Here, when loss of synchronism is detected, the error management section 241e changes the switch 241f so that the address and data are output from the other CPU (for example, the CPU 21_B) which is not the CPU (for example, the CPU 21_A) in which the loss of synchronism has occurred.

The address output from the switch 241f is set in an address queue 251 configured of a FIFO (first-in, first-out) register in which address or data (here, address) arriving first is output first. Subsequently, via the interconnect 40, the address is input to a slave request processing circuit 247_1, when the address is the address of the main storage RAM 22_1, the firmware ROM 23_1, or the register managed by this system board 20_1. In the slave request processing circuit 247_1, it is determined whether the input address is the address of the main storage RAM 22_1, the address of the firmware ROM 23_1, or the address of the register. When the input address is the address of the main storage RAM 22_1, the address is stored in a buffer 247b or a buffer 247a each configured by FIFO, depending on whether the address is a command for writing data to the main storage RAM 22_1 or a command for readout from the main storage RAM 22_1. Alternatively, when it is determined that the address is the address of the firmware ROM 23_1 in the slave request processing circuit 247_1, the address is stored in a buffer 247c or a buffer 247d, depending on whether the address is a command for data writing or a command for data readout. The firmware ROM 23_1 is not read-only, in which a log at the time of occurrence of an error, system information and the like are written and thus, the firmware ROM 23_1 also has a configuration for writing.

Further, when the address is the address indicating the register, the address is stored in a buffer 247f for writing or a buffer 247e for reading, depending on whether the address is a command for writing or a command for reading.

Furthermore, when the data for writing is output from the switch 241f, the data is temporarily stored in a write data buffer 252 configured by FIFO. Subsequently, when the data is to be written in the main storage RAM 22_1, the data is stored in the buffer 247b via the interconnect 40. Similarly, when the data is to be written in the firmware ROM 23_1, the data is stored in the buffer 247c, and when the data is to be written in the register, the data is stored in the buffer 247e.

When the data and the address are both present in the buffer 247b, a RAM controller 261 writes the data at the address of the main storage RAM 22_1. At the same time, when the data and the address are both present in the buffer 247c, a ROM controller 262 writes the data at the address of the firmware ROM 23_1. Further, when the data and the address are both present in the buffer 247c, a register RW control circuit 263 writes the data in the buffer or the like identified by the address.

Furthermore, when the address for reading is stored in the buffer 247a by the slave request processing circuit 247_1, data is read out from that address of the main storage RAM 22_1 into the RAM controller 261. The data read out is once stored in the buffer 247a and then, temporarily stored in a read data buffer 253 via the interconnect 40. Subsequently, the data is transmitted to the CPUs 21_A and 21_B via the CPU bus interfaces 241a and 241b. Similarly, when the read address is stored in the buffer 247d, data is read out by the ROM controller 262 from this read address of the firmware ROM 23_1. The data read out is transmitted to the CPUs 21_A and 21_B via the buffer 247d, the interconnect 40, the read data buffer 253, and the CPU bus interfaces 241a and 241b. Similarly, when the address is stored in the buffer 247f, data is read out by the register RW control circuit 263 from the register or the like identified by the address stored in the buffer 247f. This data read out is transmitted to the CPUs 21_A and 21_B via the buffer 247f, the interconnect 40, the read data buffer 253, and the CPU bus interfaces 241a and 241b.

A RAM base address register 264 is an element corresponding to the RAM address register 243_1 of the first embodiment illustrated in FIG. 3. When starting the synchronization upon power-on, the firmware program stored in the firmware ROM 23_1 is copied to the main storage RAM 22_1, but in the RAM base address register 264, the address of a copy destination of the main storage RAM 22_1 is stored. However, whether the address is the address of the firmware ROM 23_1 or the address of the main storage RAM 22_1 is distinguished by higher order bits, and in the RAM base address register 264, the address on the higher-order-bit side of the main storage RAM 22_1 is stored.

Further, here, there is provided a ROM-address detecting circuit 266 that determines a match or a mismatch between a ROM base address stored in a ROM-base-address storage section 265 and the address output from the switch 241f. This ROM-address detecting circuit 266 is an element corresponding to the ROM-address detecting circuit 242_1 in the first embodiment illustrated in FIG. 3. However, in the ROM-base-address storage section 265 of the second embodiment in FIG. 4, only a part of higher-order-bit side of the address of the firmware ROM 23_1 indicating a firmware program storage area is stored. Therefore, the ROM-address detecting circuit 266 determines a match or a mismatch for the address on the higher-order-bit side of the firmware ROM 23_1.

In the address queue 251, the write address or the read address is stored, but as for the lower-order-bit side of the address, the lower-order-bit side of the address output from the switch 241f is directly stored. As to the higher-order-bit side, the higher-order-bit side of the address output from the switch 241f or the higher-order-bit side of the address of the RAM 22_1 stored in the RAM base address register 264 is output, depending on selection by a selector 268. The operation after the address is stored in the address queue 251 has been described above.

A copy flag register 269 is a register to be reset at the time of reset in this system board 20_1. In this copy flag register 269, a copy flag is set at a stage where the firmware program in the firmware ROM 23_1 is copied to the RAM 22_1, and the address of a copy destination is stored in the RAM base address register 264.

In an address-replacement permitting flag register 271, an address-replacement permitting flag is set at the time of reset in this system board 20_1, in response to determination that a copy flag is stored in a copy flag register 267 by an AND gate 270. In other words, in this address-replacement permitting flag register 271, the address-replacement permitting flag is set at the time of reset for the resynchronization after occurrence of loss of synchronism between the two CPUs 21_A and 21_B.

A resynchronization reset control section 272 is requested to carryout resynchronization reset. In response to the request of the resynchronization reset, the resynchronization reset control section 272 instructs the CPUs 21_A and 21B to carry out the reset. Then, the CPUs 21_A and 21_B perform reset processing for resynchronization, including reading and running of the firmware program. Then, in this resynchronization reset processing, when the address output from the switch 241f is the address of the firmware ROM 23_1, at which the firmware program is stored, the address is replaced with the address of the copy destination of the firmware program, of the main storage RAM 22_1. Therefore, the firmware program is read from the main storage RAM 22_1 at a high speed, and the resynchronization is performed in a short time.

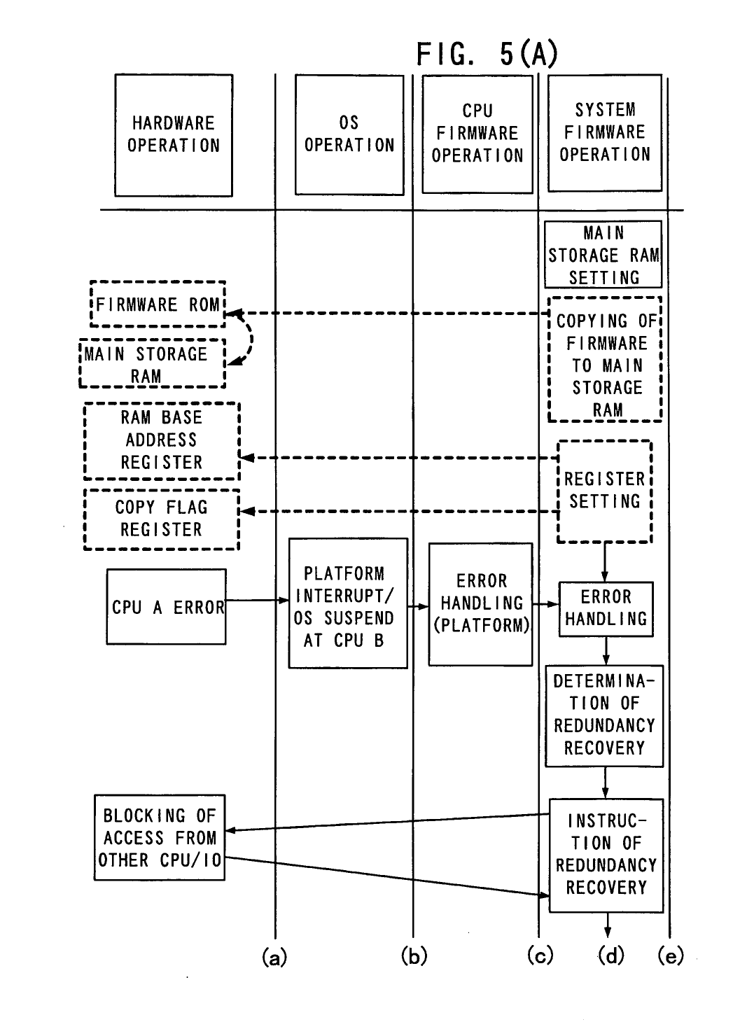

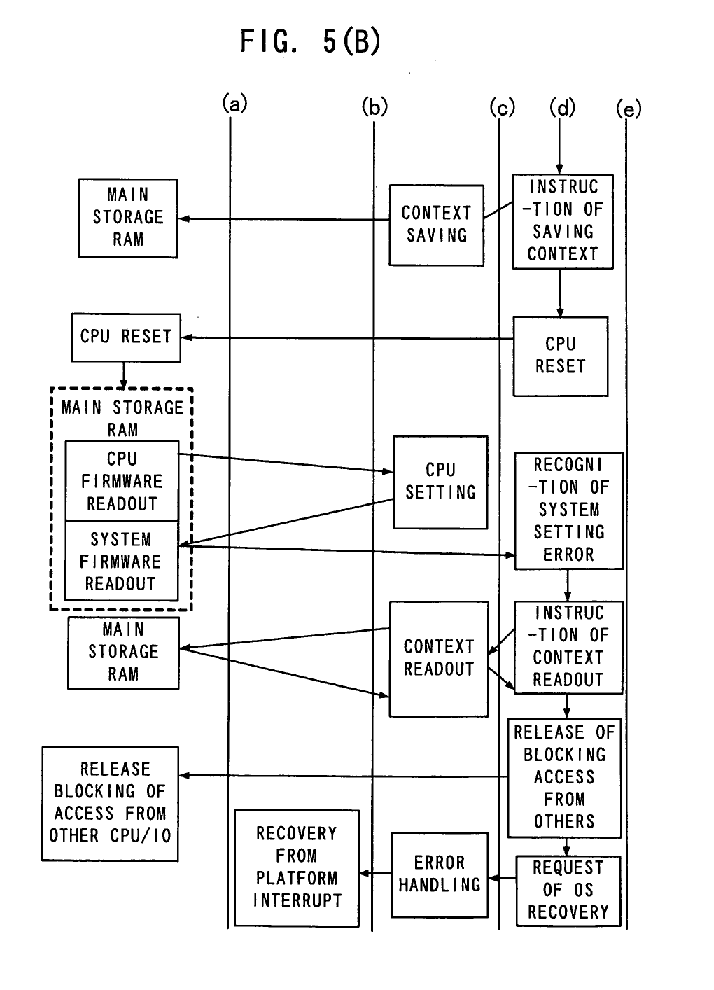

FIGS. 5(A) and 5(B) coupled with each other by connecting the same references ((a), (b), . . . , (e)) respectively are a diagram that illustrates an operating sequence of the firmware and the circuit in the second embodiment illustrated in FIG. 4.

Here, “hardware”, “OS”, “CPU firmware” and “system firmware” are illustrated separately, and the operation of each part is depicted. Here, the “CPU firmware” and “the system firmware” are both components of the firmware program stored in the firmware ROM.

Here, at first, a system firmware creates a single address map for all the main storage RAMs 22_1, 22_2, and 22_3 of the system boards across this entire information processing system so as to avoid overlaps among addresses, and sets the address in each of the main storage RAMs 22_1, 22_2 and 22_3.

Next, in the system firmware, copying the firmware program to the main storage RAM is controlled, and the firmware program on the firmware ROM in the hardware is copied to the main storage RAM. Here, as described in the first embodiment, copying of the firmware program to the main storage RAM is sufficient if the firmware program is copied to the main storage RAM of either one of the main storages RAM of each system board.

After this copying is finished, “register setting” is performed. In other words, here, the address of the copy destination in the main storage RAM to which the firmware program is copied is stored in the RAM base address register 264 (see FIG. 4), and the copy flag is set in the copy flag register 269 (see FIG. 4).

When an error occurs in the CPU 21_A (CPU A), a platform interrupt takes place, and processing of suspending the OS is performed by the CPU 21_B (CPU B). Subsequently, the CPU firmware is notified of the occurrence of the platform interrupt, a request to carry out error handling is provided from the CPU firmware to the system firmware, and the error handling is performed in the system firmware. Here, the occurrence of the error due to the loss of synchronism is recognized, and it is determined that redundancy recovery is desired. In this redundancy recovery, blocking access from other CPU or IO to the dual CPUs (CPU A/CPU B) including the CPU A in which the loss of synchronism has occurred is instructed, and thereby access blocking is performed on the hardware. Further, the system firmware is instructed to save a context on the cache of the CPU A/CPU B, and context saving operation is controlled in the CPU firmware, and the context is saved to the main storage RAM. This context is data to continue, after the resynchronization, processing that had been handled by the CPU A/CPU B.

Next, the reset of the CPU is instructed by the system firmware, and the resynchronization reset processing of the CPU A/CPU B is performed. In this resynchronization reset processing, the CPU firmware is read from the main storage RAM and thereby the CPU is set, and further, the system firmware is read from the main storage RAM and thereby the system setting is performed. At the time of this system setting, an error in synchronism is recognized, and reading of the context is instructed. Upon receipt of this instruction, the CPU firmware performs context reading processing, and the context saved into the main storage RAM on the hardware is read out. Subsequently, in the system control circuit firmware, release of blocking the access from others is instructed, and operation of releasing blocking of access from the other CPU and IO is performed on the hardware. Subsequently, an OS recovery is requested from the system firmware, and the OS recovers from a platform interrupt via the error handling by the CPU firmware.

As a result, the CPUs A and CPU B are synchronized again, and the processing performed before the loss of synchronism occurs is continued.

Next, a third embodiment of the present case will be described.

In this third embodiment and a fourth embodiment to be described later, when loss of synchronism occurs in a CPU, there is performed processing of moving, to the other CPU, information to carry on the processing performed in the CPU before execution of reset for resynchronization. Processing of leaving continuation of the processing to the other CPU is performed by this processing. The resynchronization may be performed after the information is moved to the other CPU, and returning to a state with high reliability may be performed by merely stopping the OS for an extremely short time.

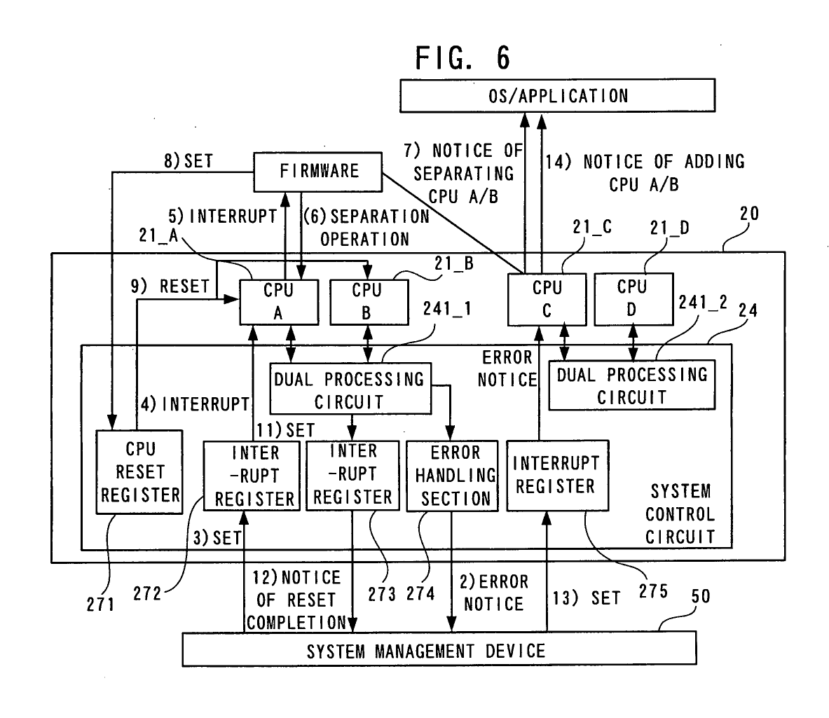

FIG. 6 is a block diagram that illustrates a configuration of an information processing system according to the third embodiment of the present case.

In this FIG. 6, for the following description, firmware or OS/application are taken out and illustrated clearly. These firmware and OS/application are programs each carrying out the following operation by being executed in a CPU.

In the information processing system of the third embodiment illustrated in this FIG. 6, one system board includes two sets of dual CPUs 21_A and 21_B, and 21_C and 21_D.

Here, suppose loss of synchronism has occurred in the CPU 21_B (CPU B). In that case, the following processing is performed.

1) The loss of synchronism in the CPU B is detected by the dual processing circuit 241_1 controlling the dual CPUs including the CPU B in which the loss of synchronism has occurred, of the dual processing circuits 241_1 and 241_2 provided for each pair of the dual CPUs. When the loss of synchronism in the CPU B is detected by the dual processing circuit 241_1, an error notice is sent to an error handling section 274. After detecting the loss of synchronism in the CPU B, the dual processing circuit 241_1 performs switching to select the address of the CPU A, so that the CPU A alone continues the processing.

2) The error handling section 274 provides the system management device 50 with an interrupt, by setting a bit representing the fact that one of the dual CPUs is retracted. The system management device 50 recognizes the one of the dual CPUs being retracted, by using the bit being set.

3) The system management device 50 sets an interrupt register 272 of a system control circuit 24.

4) The system control circuit 24 interrupts the CPU by setting of the interrupt register 272.

5) In response to this interrupt, the CPU A calls the firmware.

6) The firmware performs processing for separating the CPU A/CPU B from this information processing system.

7) The firmware notifies the OS of separation of the CPU A/CPU B.

8) The firmware sets a CPU reset register 271 of the system control circuit 24.

9) In response to this setting, the CPU reset register 271 resets the CPU A/CPU B.

10) In response to this reset, initialization is performed by the CPU A/CPU B.

11) Upon completion of the initialization, an interrupt register 273 of the system control circuit is set by the CPU A/CPU B.

12) The system control circuit 24 provides the system management device 50 with an interrupt to indicate the completion of reset.

13) The system management device sets an interrupt register 275.

14) In response to this setting, the interrupt register 275 provides the CPU C/CPU D with an interrupt, and in response to this interrupt, the CPU C/CPU D notifies the OS that the resource of the CPU A/CPU B has increased.

By executing the above method, the OS is stopped only for a shot time to separate the CPU A/CPU B, and the OS stop time during the resynchronization is reduced.

Incidentally, the processing of this third embodiment is effective in a case where the OS or application has a function of supporting dynamic deletion and dynamic addition of the CPU. When this function is not supported, it is effective to perform dynamic replacement of CPU as described below in a fourth embodiment.

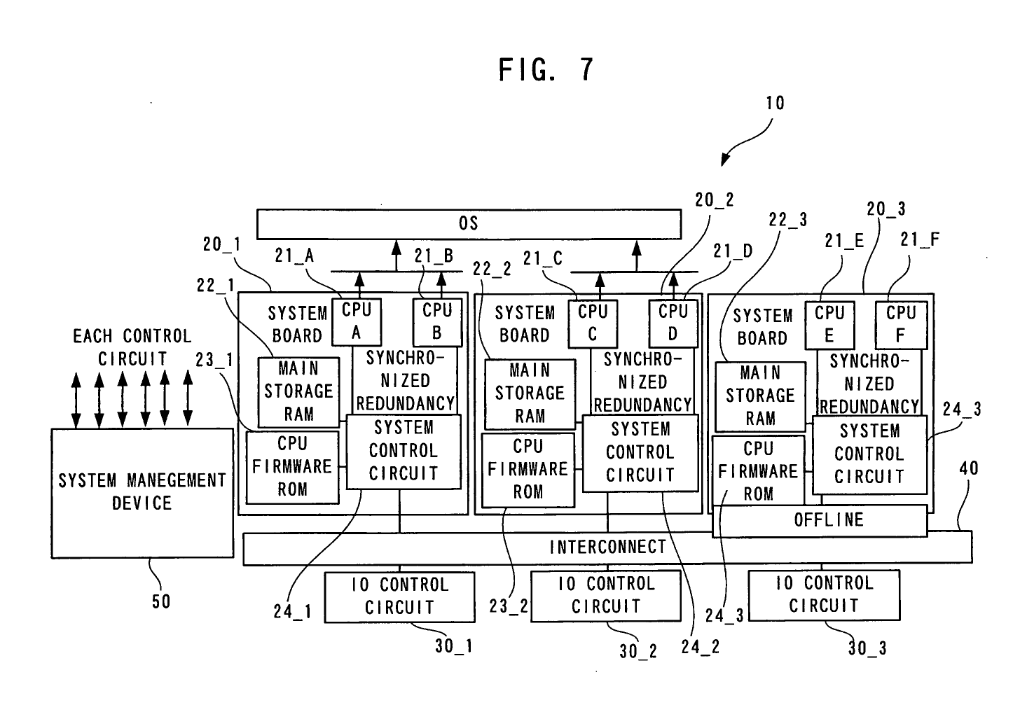

FIG. 7 is a block diagram that illustrates a configuration of an information processing system according to the fourth embodiment of the present case.

The block diagram of the information processing system illustrated in this FIG. 7 is similar to that of the information processing system illustrated in FIG. 1, and provided with the same reference characters as those in FIG. 1. A point different from FIG. 1 is that a system board 20_3 that is one of three system boards 20_1, 20_2 and 20_3 is in an off-line state of being logically separated from this information processing system 10 in an initial stage illustrated in this FIG. 7. Further, in this FIG. 7, an OS is clearly illustrated for subsequent description. This OS performs operation along the following description by being executed in the CPU.

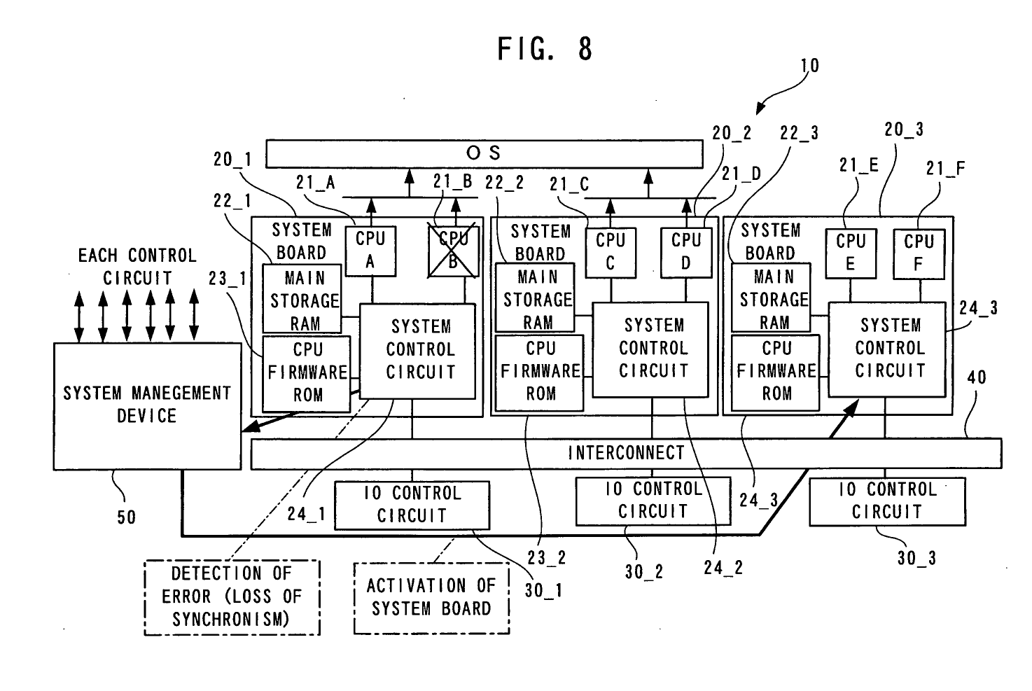

Furthermore, FIG. 8 to FIG. 13 are diagrams sequentially illustrate operations when loss of synchronism occurs in the information processing system of the fourth embodiment illustrated in FIG. 7.

As illustrated in FIG. 8, suppose an error (loss of synchronism) has occurred in a CPU B. At this moment, following each operation is executed.

The error (loss of synchronism) of the CPU B is detected by a system control circuit 24_1 responsible for the CPU B in which the loss of synchronism has occurred, and the occurrence of the error is reported to a system management device 50 (FIG. 8).

2) Upon receipt of the report on the occurrence of the error, the system management device 50 starts the system board 20_3 (FIG. 8).

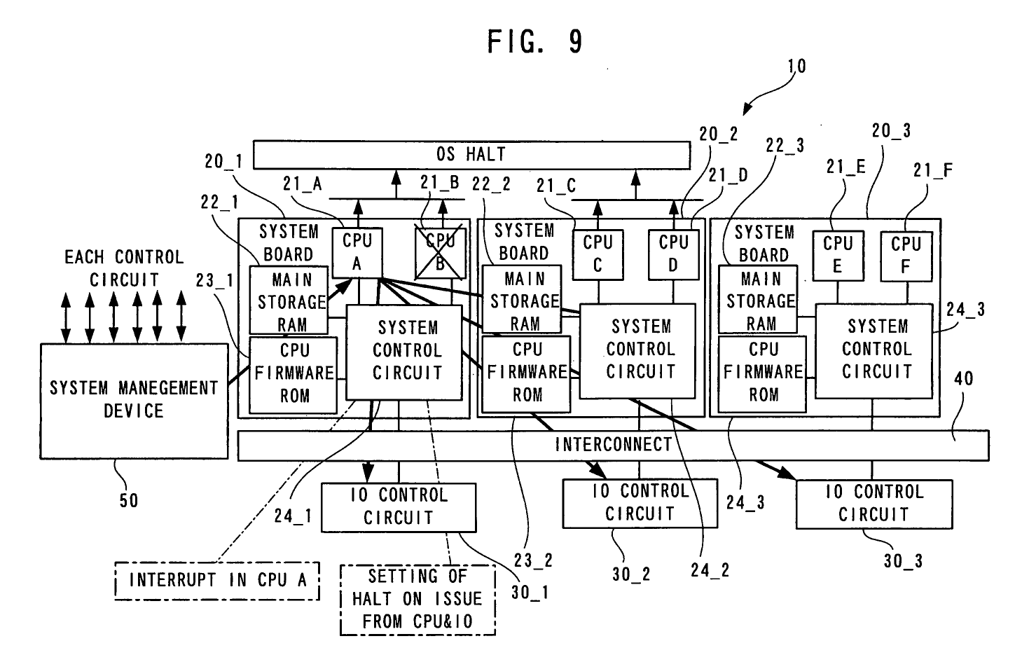

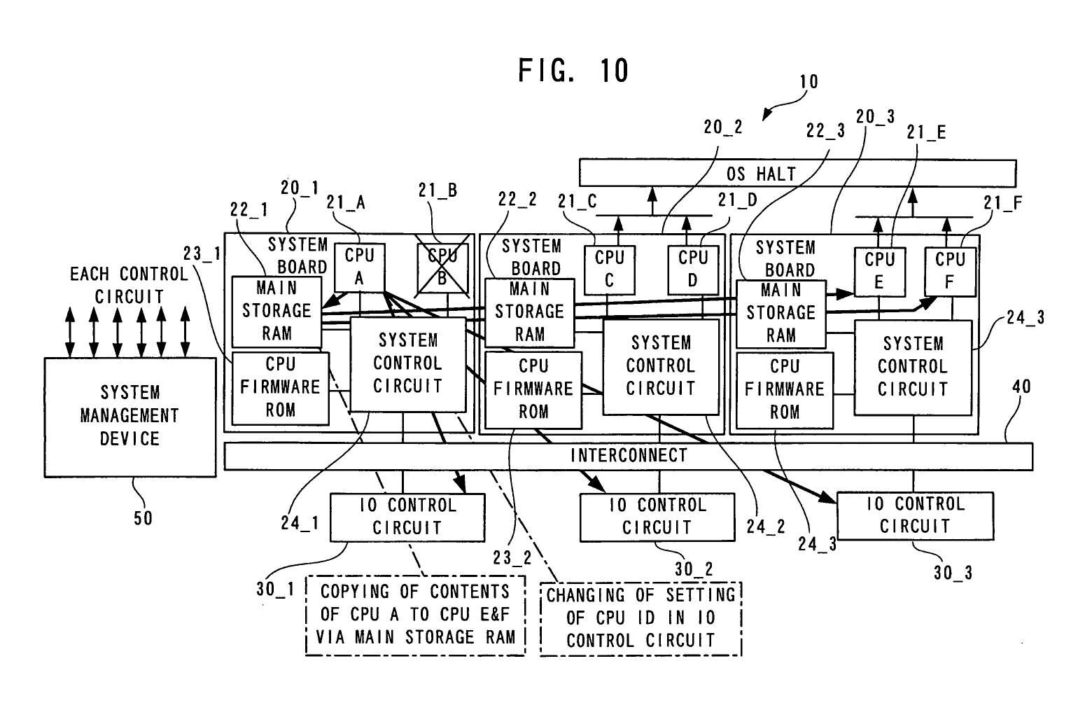

3) When the staring of the system board 20_3 is completed, the system management device 50 provides an interrupt to the CPU A that is a CPU in normal operation paired with the CPU B in which the loss of synchronism has occurred. The CPU A sets each control circuit so that requests from other CPU and IO are stopped temporarily. At this moment, the OS halts (FIG. 9).

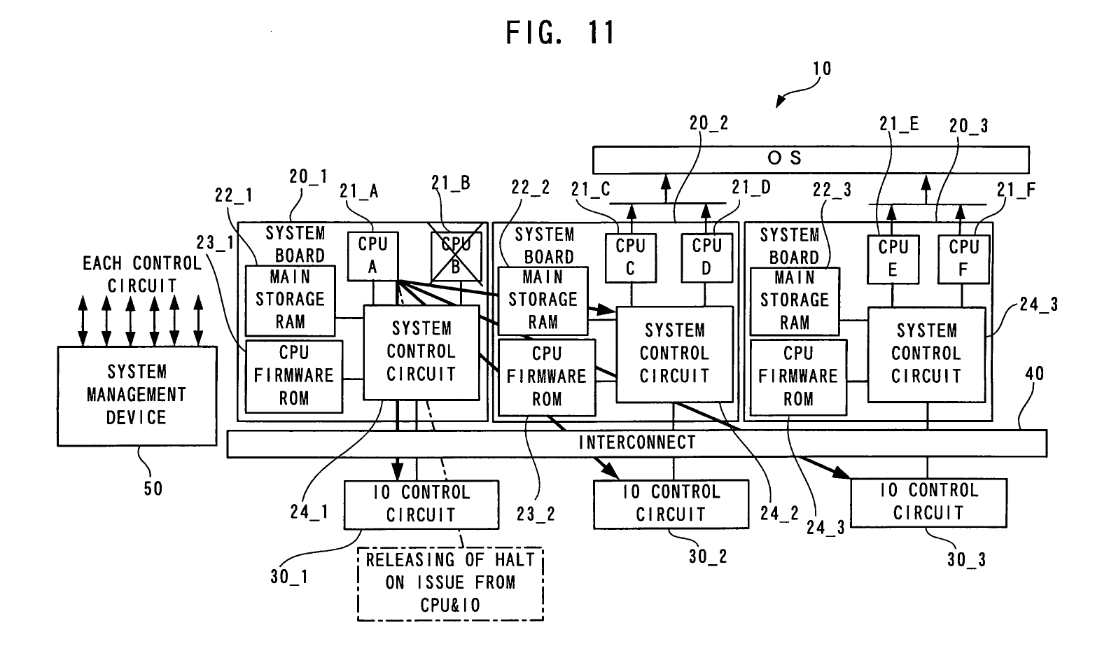

4) Information for restarting the OS of the CPU A is copied to CPU E/CPU F of the system board 20_3 via a main storage RAM 22_1 of the system board 20_1. When the copying is finished, the CPU A provides the CPU E/CPU F with a CPU ID for recognizing the CPU A. In exchange for this, the CPU_A receives a CPU ID used as the ID of the CPU E/CPU F till then, from the CPU E/CPU F. Further, in order to correctly send a packet from the IO to the CPU after the replacement, the setting of the new CPU ID is reflected on each of IO control circuits 31_1, 30_2 and 30_3 (FIG. 10).

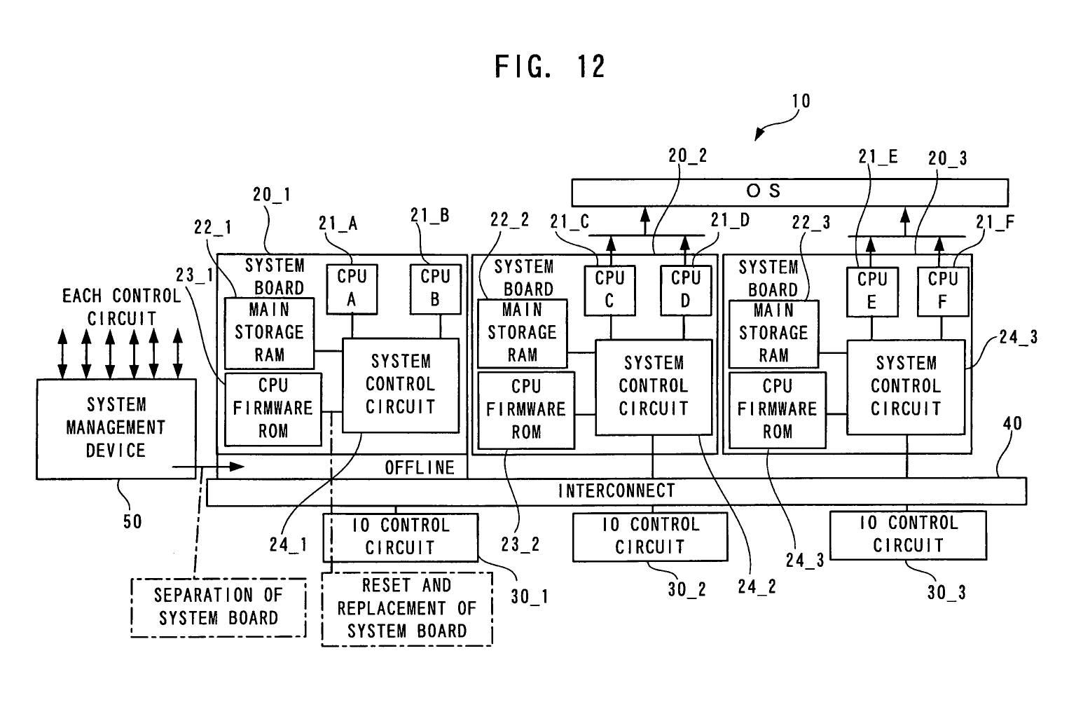

5) The setting of stopping the issuance of the requests from other CPU and IO performed in the above 3) is released, and the OS recovers (FIG. 11).

6) After the above 5) is completed, the system management device 50 is provided with an interrupt, and the system board 20_1 is separated logically (FIG. 12). Subsequently, in the system board 20_1, reset processing is performed, or the system board 20_1 is replaced.

In the case of this third embodiment, the OS is halted during the time from 4) to 5), i.e., for an extremely a short time.

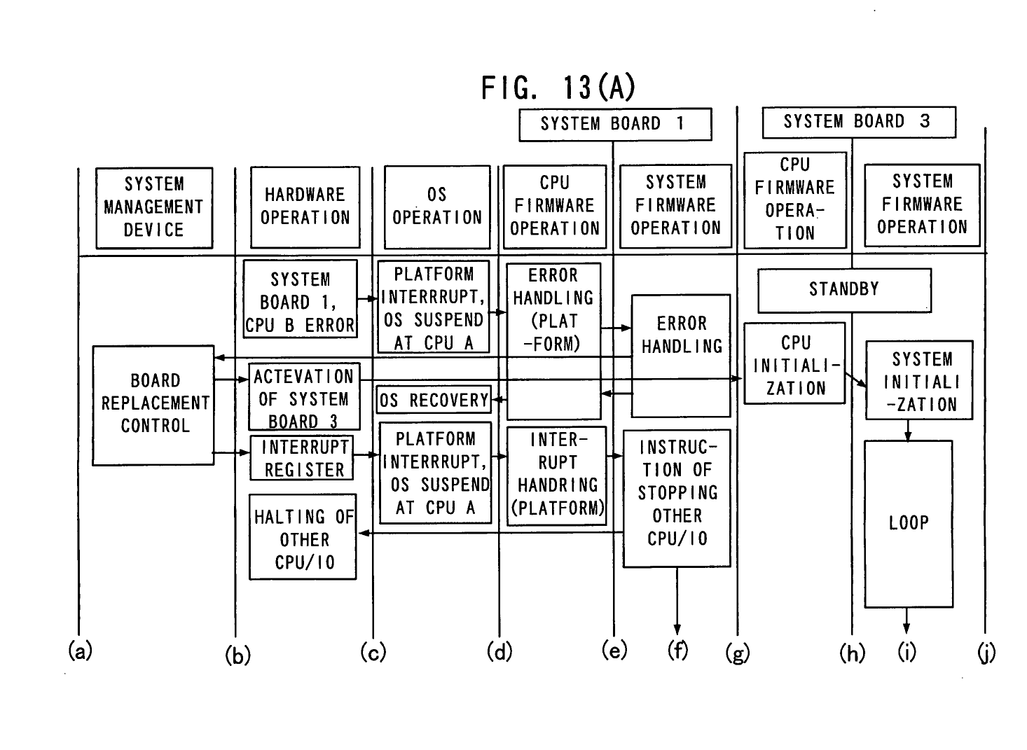

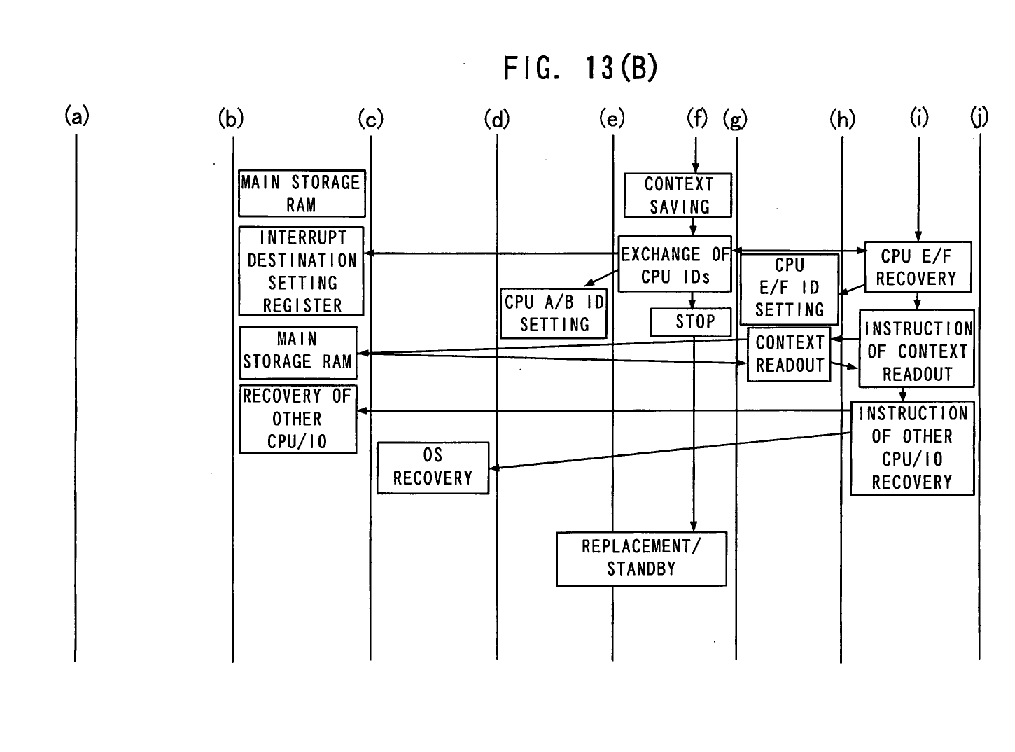

FIGS. 13(A) and 13(B) coupled with each other by connecting the same references ((a), (b), . . . , (j)) respectively are a diagram that illustrates an operating sequence of each part of the information processing system in the fourth embodiment illustrated in FIG. 8 through FIG. 12. Here, the system board 20_1 and the system board 20_3 illustrated in FIG. 8 are expressed as a system board 1 and a system board 3, respectively.

When occurrence of a loss-of-synchronism error in the CPU B of the system board 1 is detected on hardware, a platform interrupt is given to the OS, and suspend processing of the OS is performed by the CPU A. Further, error handling of the platform is raised to a CPU firmware of the system board 1 and furthermore, the error handling is performed by a system firmware of the system board 1. In this error handling, the error is reported to the system management device 50, and board replacement control is performed by the system management device 50. In other words, here, the system board 3 on standby before that moment is activated, initialization of the CPU E/CPU F is performed by the CPU firmware and further, system initialization on the system board 3 is performed by the system firmware. After this initialization, the system board 3 enters a loop state (a wait state) for a while. The system management device 50 further sets an interrupt flag in an interrupt register. Then, the platform interrupt by setting the flag is accepted by the CPU A, and the OS suspends. Interrupt handling by the platform interrupt is performed in the CPU firmware of the system board 1, and the processing is transferred to the system firmware, and a halt of other CPU and IO is instructed by the system firmware. On the hardware, in response to this instruction, requests from other CPU and IO are stopped. Further, context saving processing is performed in the system firmware of the system board 1, and the context is saved into the main storage RAM. Furthermore, in the system firmware of the system board 1, exchange of CPU IDs between the CPU A and the CPU E/CPU F is performed, a new CPU ID is set in an interrupt destination setting register in each control circuit. In addition, the CPU ID received from the system board 3 is set by the CPU firmware of the system board 1 and then, the system board 1 is stopped, and replacement/standby or the like is performed.

In the system board 3, the CPU E/CPU F in the loop state (wait state) returns to an active state, and the CPU ID received from the system board 1 is set as the CPU ID of the CPU E/CPU F. Further, in the system firmware of the system board 3, reading of the context is instructed, and context reading processing is performed by the CPU firmware of the system board 3, and the reading of the context saved into the main storage RAM is performed. In the system firmware of the system board 3, recovery of other CPU and IO is further instructed, and recovery processing of other CPU and IO is performed in order to accept requests from other CPU and IO again. Further, the OS recovers.

According to the fourth embodiment described above, the OS may be stopped only for a short time until the operation of the system board 1 is transferred to the system board 3 and thus, the stop time after the occurrence of the loss of synchronism may be extremely short.

As described above, according to each embodiment described above, the stop time after the loss of synchronism may be short. Further, the timeout may not be set as a long time and thus, general-purpose components may be used.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system that includes a plurality of sets of two or more multiple processors that perform processing in synchronization with each other, comprising:
a non-volatile memory that stores a firmware program activating the multiple processors to a state in which the multiple processors are synchronized with each other;
a volatile memory that is defined by one address map as a whole;
a firmware copying section that copies the firmware program stored in the non-volatile memory to the volatile memory, on system boot;
a volatile memory address register in which an address of the volatile memory and of a copy destination to which the firmware program is copied is stored;
a volatile memory address storing section that stores the address of the volatile memory and of the copy destination to which the firmware program is copied by the firmware copying section, in the volatile memory address register;
a loss-of-synchronism detection section that detects loss of synchronism of the multiple processors; and
an address replacing section that refers to the volatile memory address register in response to the loss of synchronism being detected by the loss-of-synchronism detection section, to replace an address for reading the firmware program stored in the non-volatile memory, with the address of the volatile memory and of the copy destination of the firmware program.

2. The information processing system according to claim 1, further comprising:
a copy flag register in which a copy flag indicating that the firmware program is copied to the volatile memory is stored; and
a copy flag storing section that stores the copy flag in the copy flag register, in response to the firmware program being copied to the volatile memory by the firmware copying section, wherein
the address replacing section refers to the copy flag register in response to the loss of synchronism being detected by the loss-of-synchronism detection section, and when the copy flag is stored in the copy flag register, replaces the address for reading the firmware program stored in the non-volatile memory, with the address of the volatile memory and of the copy destination of the firmware program.

3. The information processing system according to claim 1, further comprising:
a context saving section that saves a context for continuing operation after resynchronization into the volatile memory, prior to reading of the firmware program, in response to the loss of synchronism being detected by the loss-of-synchronism detection section; and
a context reading section that reads the context saved into the volatile memory, after the firmware program is read out.

4. The information processing system according to claim 2, further comprising:
a context saving section that saves a context for continuing operation after resynchronization into the volatile memory, prior to reading of the firmware program, in response to the loss of synchronism being detected by the loss-of-synchronism detection section; and
a context reading section that reads the context saved into the volatile memory, after the firmware program is read out.

5. An information processing system that includes a plurality of sets of two or more multiple processors, and a system management device managing the plurality of sets of multiple processors, comprising:
a non-volatile memory that stores a firmware program activating the multiple processors to a state in which the multiple processors are synchronized with each other;
a volatile memory that is defined by one address map as a whole;
a loss-of-synchronism detection section that detects loss of synchronism of the multiple processors, and reports the loss of synchronism to the system management device; and
a separation processing section that logically separates the multiple processors from the information processing system, upon receipt of a separation instruction from the system management device, wherein
the system management device includes a separation instructing section that instructs, in response to the system management device receiving a report on loss of synchronism in any of the plurality of sets of multiple processors, a processor continuing normal operation of first multiple processors in which the loss of synchronism has occurred, to logically separate the first multiple processors from the information processing system.

6. The information processing system according to claim 5, wherein the system management device includes an addition instructing section that provides an instruction of logically adding the first multiple processors to the information processing system, in response to completion of resynchronization in the first multiple processors after being logically separated.

7. The information processing system according to claim 5, wherein
the plurality of sets of multiple processors include second multiple processors logically separated from the information processing system, and
the system management device includes an entry instructing section that provides an instruction of making a logical entry of the second multiple processors into the information processing system, in response to the system management device receiving a report on loss of synchronism in any of the plurality sets of multiple processors, and
the separation instructing section makes logical separation from the information processing system after transferring processing performed in the first multiple processors to the second multiple processors newly entered the information processing system, in response to a separation instruction from the system management device.

8. The information processing system according to claim 7, wherein the separation processing section separating the first multiple processors informs the second multiple processors of an ID of the first multiple processors as an ID of the second multiple processors newly entered the information processing system, in response to the separation instruction from the system management device.

9. The information processing system according to claim 8, further comprising:
a context saving section that saves a context for continuing processing performed in the first multiple processors with the second multiple processors into the volatile memory, in response to the separation instruction from the system management device, when being in a position of the first multiple processors; and
a context reading section that reads the context from the volatile memory, when being in a position of the second multiple processors and newly entering the information processing system.

10. A resynchronization method in an information processing system including a plurality of sets of two or more multiple processors that perform processing in synchronization with each other, the information processing system including
a non-volatile memory that stores a firmware program activating the multiple processors to a state in which the multiple processors are synchronized with each other,
a volatile memory that is defined by one address map as a whole, and
a volatile memory address register in which an address of the volatile memory and of a copy destination to which a firmware program is copied is stored, and
the resynchronization method comprising:
copying the firmware program stored in the non-volatile memory to the volatile memory, on system boot;
storing the address of the volatile memory and of the copy destination of the firmware program, in the volatile memory address register;
detecting loss of synchronism of the multiple processors; and
replacing an address for reading the firmware program stored in the non-volatile memory, with the address of the volatile memory and of the copy destination of the firmware program, by referring to the volatile memory address register in response to the loss of synchronism being detected.

11. A resynchronization method in an information processing system including a plurality of sets of two or more multiple processors, and a system management device managing the plurality of sets of multiple processors, the information processing system including
a non-volatile memory that stores a firmware program activating the multiple processors to a state in which the multiple processors are synchronized with each other, and
a volatile memory that is defined by one address map as a whole, and
the resynchronization method comprising:
detecting loss of synchronism of the multiple processors, and reporting the loss of synchronism to the system management device; and
instructing, in response to the system management device receiving a report on loss of synchronism in any of the plurality of sets of multiple processors, a processor continuing normal operation of first multiple processors in which the loss of synchronism has occurred, to logically separate the first multiple processors from the information processing system, the separation being performed in the system management device; and
logically separating the first multiple processors from the information processing system, in response to a separation instruction from the system management device, the separation being executed in the processor continuing the normal operation of the first multiple processors.

12. A non-transitory storage medium that stores a firmware program executed in an information processing system including a plurality of sets of two or more multiple processors that perform processing in synchronization with each other,
the information processing system including
a non-volatile memory that stores a firmware program activating the multiple processors to a state in which the multiple processors are synchronized with each other,
a volatile memory that is defined by one address map as a whole, and
a volatile memory address register in which an address of the volatile memory and of a copy destination to which a firmware program is copied is stored, and
the firmware program causing the information processing system to operate as the information processing system comprising:
a firmware copying section that copies the firmware program stored in the non-volatile memory to the volatile memory, on system boot;
a volatile memory address storing section that stores the address of the volatile memory and of the copy destination to which the firmware program is copied by the firmware copying section, in the volatile memory address register;
a loss-of-synchronism detection section that detects loss of synchronism of the multiple processors; and
an address replacing section that refers to the volatile memory address register in response to the loss of synchronism being detected by the loss-of-synchronism detection section, to replace an address for reading the firmware program stored in the non-volatile memory, with the address of the volatile memory and of the copy destination of the firmware program.

13. A non-transitory storage medium that stores a firmware program executed in an information processing system including a plurality of sets of two or more multiple processors, and a system management device managing the plurality of sets of multiple processors, the information processing system including
a non-volatile memory that stores a firmware program activating the multiple processors to a state in which the multiple processors are synchronized with each other, and
a volatile memory that is defined by one address map as a whole, and
the firmware program causing the information processing system to operate as the information processing system comprising:
a loss-of-synchronism detection section that detects loss of synchronism of the multiple processors, and reports the loss of synchronism to the system management device; and
a separation processing section that logically separates the multiple processors from the information processing system, upon receipt of a separation instruction from the system management device.
